(19) United States
(12) Patent Application Publication
(10) Pub. No.: US 2023/0360502 A1
(43) Pub. Date: Nov. 9, 2023

(54) IMAGE BASED POS SYSTEM FOR THE FAST FOOD INDUSTRY

(71) Applicants: SOYKAN DIRIK, Laguna Niguel, CA (US); MEHMET KAPTANA, IRVINE, CA (US)

(72) Inventors: SOYKAN DIRIK, Laguna Niguel, CA (US); MEHMET KAPTANA, IRVINE, CA (US)

(21) Appl. No.: 18/223,099

(22) Filed: Jul. 18, 2023

(51) Int. Cl. G07G 1/00; G06V 30/19

(52) U.S. Cl. CPC G07G 1/0009; G06V 30/19007

(57) ABSTRACT

An image based POS system for the fast food industry, wherein the visualized order information is processed through an OCR, the HDMI port is used for video processing, data from a separate database (a server) is retrieved, and the products served by the premises are matched by one or more OCR images.

### FIELD OF THE INVENTION

The present invention belongs to the field of POS systems for the fast food industry. More particularly, the present invention relates to an image based POS system for the fast food industry.

### BACKGROUND OF THE INVENTION

The point of sale (POS) or point of purchase (POP) is the time and place where a retail transaction is completed. At the point of sale, the customer places her order, the merchant calculates the amount owed by the customer, indicates that amount, may prepare an invoice for the customer (which may be a cash register printout), and indicates the options for the customer to make payment. It is also the point at which a customer makes a payment to the merchant in exchange for goods or after provision of a service. After receiving payment, the merchant may issue a receipt for the transaction, which is usually printed but can also be dispensed with or sent electronically.

To calculate the amount owed by a customer, the merchant may use various devices such as weighing scales, barcode scanners, and cash registers—or the more advanced “POS cash registers”, which are sometimes also called “POS systems”. To make a payment, payment terminals, touch screens, and other hardware and software options are available. POS terminal software may also include features for additional functionality, such as inventory management, CRM, financials, or warehousing.

Businesses are increasingly adopting POS systems, and one of the most obvious and compelling reasons is that a POS system eliminates the need for price tags. Selling prices are linked to the product code of an item when adding stock, so the cashier merely scans this code to process a sale. If there is a price change, this can also be easily done through the inventory window. Other advantages include the ability to implement various types of discounts, a loyalty scheme for customers, and more efficient stock control. These features are typical of almost all modern ePOS systems.

Early electronic cash registers (ECR) were controlled with proprietary software and were limited in function and communication capability.

One of the first microprocessor-controlled cash register systems was built by William Brobeck and Associates in 1974, for McDonald's Restaurants. It used the Intel 8008, an early microprocessor (forerunner to the Intel 8088 processor used in the original IBM Personal Computer). Each station in the restaurant had its own device which displayed the entire order for a customer—for example, [2] Vanilla Shake, [1] Large Fries, [3] BigMac—using numeric keys and a button for every menu item.

In 1986, Eugene “Gene” Mosher introduced the first graphical point of sale software featuring a touchscreen interface under the ViewTouch trademark on the 16-bit Atari 520ST color computer. It featured a color touchscreen widget-driven interface that allowed configuration of widgets representing menu items without low level programming.

In 1986, IBM introduced its 468x series of POS equipment based on Digital Research's Concurrent DOS 286 and FlexOS 1.xx, a modular real-time multi-tasking multi-user operating system.

In 1993, IBM adopted FlexOS 2.32 as the basis of their IBM 4690 OS in their 469x series of POS terminals. This was developed up to 2014 when it was sold to Toshiba, who continued to support it up to at least 2017.

POS systems are one of the most complex software systems available because of the features that are required by different end users. Many POS systems are software suites that include sale, inventory, stock counting, vendor ordering, customer loyalty and reporting modules. Sometimes purchase ordering, stock transferring, quotation issuing, barcode creating, bookkeeping or even accounting capabilities are included. Each of these modules is interlinked if they are to serve their practical purpose and maximize their usability.

For instance, the sale window is immediately updated on a new member entry through the membership window because of this interlinking. Similarly, when a sale transaction is made, any purchase by a member is on record for the membership window to report providing information like payment type, goods purchased, date of purchase and points accumulated. Comprehensive analysis performed by a POS machine may need to process several qualities about a single product, like selling price, balance, average cost, quantity sold, description and department. Highly complex programming is involved (and possibly considerable computer resources) to generate such extensive analyses.

POS systems are designed not only to serve the retail, wholesale and hospitality industries as historically is the case. In the hospitality industry, POS system capabilities can also diverge significantly. For instance, while a restaurant is typically concerned about how the sale window functions: whether it has functionality such as creating item buttons, various discounts, adding a service charge, holding of receipts, queuing, table service as well as takeaways, merging and splitting of a receipt.

With regards to databases, POS systems are very demanding on their performance because of numerous submissions and retrievals of data-required for correct sequencing the receipt number, checking various discounts, membership, calculating subtotal, so forth—just to process a single sale transaction. The immediacy required of the system on the sale window such as may be observed at a checkout counter in a supermarket cannot be compromised. This places much stress on individual enterprise databases if there are just several tens of thousands of sale records in the database.

Enterprise database Microsoft SQL Server, for example, has been known to freeze up (including the OS) entirely for many minutes under such conditions showing a “Timeout Expired” error message. Even a lighter database like Microsoft Access will slow to a crawl over time if the problem of database bloating is not foreseen and managed by the system automatically. Therefore, the need to do extensive testing, debugging and improvisation of solutions to preempt failure of a database before commercial implementation complicates the development.

Hardware Interface Standardization (post-1980s)

Vendors and retailers are working to standardize development of computerized POS systems and simplify interconnecting POS devices. Two such initiatives were OPOS and JavaPOS, both of which conform to the UnifiedPOS standard led by The National Retail Foundation.

OPOS (OLE for POS) was the first commonly adopted standard and was created by Microsoft, NCR Corporation, Epson and Fujitsu-ICL. OPOS is a COM-based interface compatible with all COM-enabled programming languages for Microsoft Windows. OPOS was first released in 1996. JavaPOS was developed by Sun Microsystems, IBM, and NCR Corporation in 1997 and first released in 1999. JavaPOS is for Java what OPOS is for Windows, and thus largely platform independent.

There are several communication ways POS systems use to control peripherals such as:
Logic Controls\BemaTech
Epson Esc/POS
UTC Standard
UTC Enhanced
AEDEX
ICD 2002
Ultimate
CD 5220
DSP-800
ADM 787/788
HP

There are also nearly as many proprietary protocols as there are companies making POS peripherals. Most POS peripherals, such as displays and printers, support several of these command protocols to work with many different brands of POS terminals and computers.

Point of sale systems have revolutionized the restaurant industry, particularly in the fast food sector. In the most recent technologies, registers are computers, sometimes with touch screens. The registers connect to a server, often referred to as a “store controller” or a “central control unit”. Printers and monitors are also found on the network. Additionally, remote servers can connect to store networks and monitor sales and other store data.

Typical restaurant POS software is able to create and print guest checks, print orders to kitchens and bars for preparation, process credit cards and other payment cards, and run reports. In addition, some systems implement wireless pagers and electronic signature-capture devices.

In the fast food industry, displays may be at the front counter, or configured for drive-through or walk-through cashiering and order taking. Front counter registers allow taking and serving orders at the same terminal, while drive-through registers allow orders to be taken at one or more drive-through windows, to be cashiered and served at another. In addition to registers, drive-through and kitchen displays are used to view orders. Once orders appear they may be deleted or recalled by the touch interface or by bump bars. Drive-through systems are often enhanced by the use of drive-through wireless (or headset) intercoms. The efficiency of such systems allows decreased service times and increased efficiency of orders.

Newer, more sophisticated systems are departing from the central database “file server” type system and going to what is called a “cluster database”. This eliminates any crashing or system downtime that can be associated with the back office file server. This technology allows 100% of the information to not only be stored, but also pulled from the local terminal, thus eliminating the need to rely on a separate server for the system to operate.

The selection of a restaurant POS system is critical to the restaurant's daily operation and is a major investment that the restaurant's management and staff must endure for many years. The restaurant POS system interfaces with all phases of the restaurant operation, and with everyone that is involved with the restaurant including guests, suppliers, employees, managers and owners. The selection of a restaurant POS system is a complex process that should be undertaken by the restaurant owner and not delegated to an employee.

Some of the popular POS systems for restaurants as of 2022 are:
Touch Bistro
Square
Upserve
Lightspeed
Clover
Revel
Toast

POS systems for the fast food industry are known in the art.

JP2002358578A discloses a drive through ordering system. JP2002358578A identifies the problem and the solution as follows:
“PROBLEM TO BE SOLVED: To provide a drive through ordering system by which commodities can be delivered speedily. SOLUTION: A customer designates a store for buying commodities and transmits a name of commoditie to be bought, the number of the commodities to be bought, user ID, etc., to the server 2 of a center by using a car navigation 1. When receiving a name of commoditie to be bought, the number of the commodities to be bought, etc., the server 2 transmits a receipt number to the car navigation 1 of the customer. When approaching the store for buying the commodity by a fixed distance, a message to the effect is transmitted to the server 2. The server 2 transmits order information including the receipt number, the name of commodities to be bought, the number of the commodities to be bought, the user ID, etc., of the customer to a store terminal 3, which presents the received order information. The clerk of the store prepares the commodities by referring to the presented order information. The store recognizes arriving of the customer by a receiver, etc., for receiving the user ID, etc., and delivers the commodities to the orderer.”

The present invention is distinguished from the prior art, as disclosed below.

### DESCRIPTION OF THE INVENTION

The following description is presented to enable any person skilled in the art to make and use the invention, and is provided in the context of particular applications of the invention and their requirements. The present invention can be configured as follows:

The POS systems currently used in the fast food industry initially receive the order from the customer. Thereafter, the order received is distributed as an image to one or more points in the premises for human perception. Currently, the POS systems used in the fast food industry is integrated, i.e. SAP, Oracle, AS400 or some other integrated structure runs the POS system.

This creates a problem down the road, because even if there is a single integrated structure initially—such as SAP, Oracle, or AS400—the integrated structure needs periodic updates and upgrades. Furthermore, if there is more than one data component, those components need to be able to talk to each other.

The present invention discloses an image based processing. In specific, the current invention discloses an OCR based processing.

The present invention relies on the fact that, existing POS systems at some point convert the order information to an image for human perception. In specific, the order of the customer, for example, may be punched in by an employee at the register, which is then relayed back to the sandwich station and the beverages station. At that point, the order information is visualized, for example, as a screen image for employees, i.e. for human perception. This is the point where the current invention distinguishes from prior art.

Currently, the existing art tries to integrate different database languages and different protocols through regular electronic integration, which creates many technical problems as detailed above.

The current invention discloses that such visualized order information can be processed through an OCR, thereby eliminating the need for direct electronic integration.

In specific, the current invention discloses that the HDMI port can be used for video processing.

The current invention further discloses a video interface.

An embodiment of the invention comprises a separate database (i.e., a server) within the disclosed machine. The machine retrieves the data from this server and carries out the transaction. For example, during the set up, the disclosed machine creates a list of the beverages served by the restaurant on its server and matches one or more OCR images with each beverage. Thereby, for every beverage-including-order image retrieved from the HDMI port by the OCR, there exists a corresponding beverage, which the disclosed machine further processes. Similarly, there is a list for sandwiches. This separate database allows swift adaptability in case a new item is introduced by the restaurant. In the prior art, the addition of a new item potentially requires updates and upgrades in different databases and programming languages.

In this application, the terminology ‘embodiment’ can be used to describe any aspect, feature, process or step, any combination thereof, and/or any portion thereof, etc. While the invention has been described in connection with specific embodiments thereof, it will be understood that it is capable of further modifications and this application is intended to cover any variations, uses or adaptations of the invention following, in general, the principles of the invention and including such departures from the present disclosure come within known or customary practice within the art to which the invention pertains and may be applied to the essential features herein before set forth. Further it will be apparent to those skilled in the art that the objects of the present invention have been achieved by providing the above invention. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. Therefore, the scope of the invention is to be determined by the terminology of the above description and the legal equivalents thereof.

1. An image based POS system for the fast food industry, wherein:
a. visualized order information is processed through an OCR, and
b. the HDMI port is used for video processing, and
c. data from a separate database (a server) is retrieved, and
d. products served by the premises are matched by one or more OCR images.
